(19) United States
(12) Patent Application Publication
(10) Pub. No.: US 2018/0099456 A1
(43) Pub. Date: Apr. 12, 2018

(54) Laser Welding System and Method for Producing Image-Containing Weld Seam

(71) Applicant: Dukane IAS, LLC, St. Charles, IL (US)

(72) Inventors: Alexander Savitski, Arlington Heights, IL (US); Paul H. Cathcart, St. Charles, IL (US); Leo Klinstein, Glenview, IL (US)

(21) Appl. No.: 15/291,600

(22) Filed: Oct. 12, 2016

(51) Int. Cl. B29C 65/16; B29C 59/02; B65B 51/22

(52) U.S. Cl. CPC B29C 65/1635; B29K 2101/12; B65B 51/22; B29C 59/026

(57) ABSTRACT

A laser welding method and system join portions of two workpieces of thermoplastic material by clamping together the portions of the workpieces to be joined, against a baseplate engraved or etched to form an image to be replicated in the joined portions of the workpieces, and applying laser radiation to the portions of the clamped workpieces to be joined, to melt those portions of the clamped workpieces to be joined and to replicate the image in the joined portions of the clamped workpieces when the material solidifies. The thermoplastic material of the workpieces can be optically transparent but absorbs a portion of the laser radiation, so that both workpieces are heated and melted by the laser radiation. A portion of the melted workpiece material flows into the engraved or etched portions of the baseplate, forming an embossed surface on the lower surface of the area where the workpieces are joined.

### FIELD OF THE INVENTION

This invention relates generally to laser welding of thermoplastic materials and, more particularly, to laser welding that produces a desired image in the weld zone produced by the laser welding.

### BACKGROUND

Laser welding uses a laser beam to melt thermoplastic material in a joint area by delivering a controlled amount of energy to a precise location. Systems have been developed for controlling the beam size, and a variety of methods are available for precisely positioning and moving the beam. Laser welding is based on the same basic requirements of material compatibility as other welding techniques, but is often found to be more forgiving of resin chemistry or melt temperature differences than most other plastic welding processes. Nearly all thermoplastics can be welded using a proper laser source and appropriate joint design.

### SUMMARY

In accordance with one embodiment, a laser welding method is provided for joining portions of two workpieces of thermoplastic material by clamping together the portions of the workpieces to be joined, against a baseplate engraved or etched to form an image to be replicated in the joined portions of the workpieces, and applying laser radiation to the portions of the clamped workpieces to be joined, to melt those portions of the clamped workpieces to be joined and to replicate the image in the joined portions of the clamped workpieces. The thermoplastic material of the workpieces can be optically transparent but absorbs a portion of the laser radiation, so that both workpieces are heated and melted by the laser radiation. A portion of the melted workpiece material flows into the engraved or etched portions of the baseplate, forming an embossed surface on lower surface of the area where the workpieces are joined. The laser radiation is preferably a 2-micron laser. The power of the laser radiation and the rate of movement of the laser radiation along the clamped workpieces is controlled to melt the workpieces in the areas to be joined. The baseplate is made of a material that is non-transmissive for the laser radiation.

The invention also contemplates a laser welding system for joining portions of two workpieces of thermoplastic materials. The system includes a pair of clamping plates positioned to engage opposite sides of the first and second workpieces when the workpieces are adjoining each other with contacting surfaces, one of the clamping plates has engraved or etched cavities that form an image to be replicated in the joined portions of the workpieces. An actuator urges at least one of the clamping plates toward the other clamping plate to press the workpieces together, while laser radiation is applied to the portions of the clamped workpieces to be joined. The laser radiation is applied from the opposite side of the workpieces from the side engaging the plate surface having the engraved or etched portions. The laser radiation melts portions of the clamped workpieces to be joined, and replicates the image in the joined portions of the clamped workpieces. In one implementation, the laser radiation preferably has a wavelength of about 2 microns. The cavities are preferably engraved or etched in the surface of the one of the clamping plates.

### BRIEF DESCRIPTION OF THE DRAWINGS

FIG. 1 is an exploded perspective view of a laser welding arrangement for welding two thermoplastic sheets while also forming legible indicia in the weld zone.

FIG. 2 is an enlarged of the front corner of the lower plate in the welding arrangement of FIG. 1, with the tip of the corner removed.

FIG. 3 is an enlarged and exploded view of the left corner of the section cut away from FIG. 2.

FIG. 4 is the same view shown in FIG. 3 but not exploded, with a laser beam penetrating all the layers above the base plate.

FIG. 5 is the same view shown in FIG. 3 after the welding has been effected by the laser beam.

FIG. 6 is the same view shown in FIG. 5 but exploded.

FIG. 7 is an enlarged perspective of the middle section in FIG. 6, but inverted to shown the embossed surface formed on the bottom surface of that section.

FIG. 8 is a perspective view of the middle section in FIG. 6 during an initial stage of a laser welding operation.

FIG. 9 is a perspective view of the middle section in FIG. 6 during a later stage of a laser welding operation.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications and equivalent arrangements as may be included within the spirit and scope of invention as defined by the appended claims.

Turning now to the drawings, a laser source 10 generates a laser that is transmitted through a fiber cable 11 to a scan head 12 attached to a mount 12a. The mount 12a is coupled to orthogonal gantries 14a and 14b. One or more scanner mirrors within the scan head 12 are controlled by a processor-controlled drive unit 13 to direct a laser beam 15 downwardly onto a stack 16 that includes two thermoplastic workpieces 21 and 23 to be joined by welding. The drive unit 13 is controlled to adjust the positions of the scanner mirrors to move the laser beam 15 in a manner required to illuminate a prescribed weld zone on the top surface of the stack 16.

As depicted in FIG. 2, the two workpieces 20 and 21 are clamped together by a pair of clamping plates 22 and 23, as is conventional in laser welding of thermoplastic workpieces. The upper plate 22 is transmissive, i.e., the laser beam can pass through the upper plate with virtually no loss. This upper plate 22 is preferably made of glass. The lower plate 23 is non-transmissive, i.e., the laser cannot penetrate the lower plate 23 and thus is diffracted against the lower plate, which is sometimes referred to as a “nest.” Both clamping plates are rigid, and the lower plate 23 is preferably made of metal.

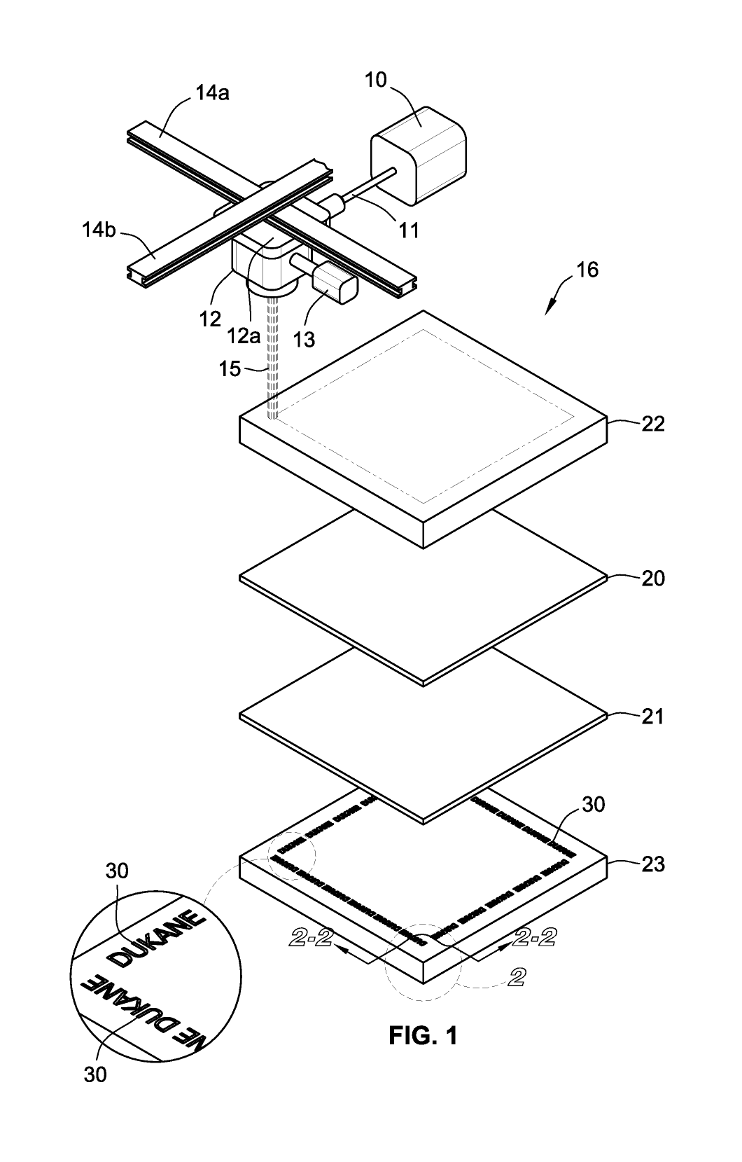

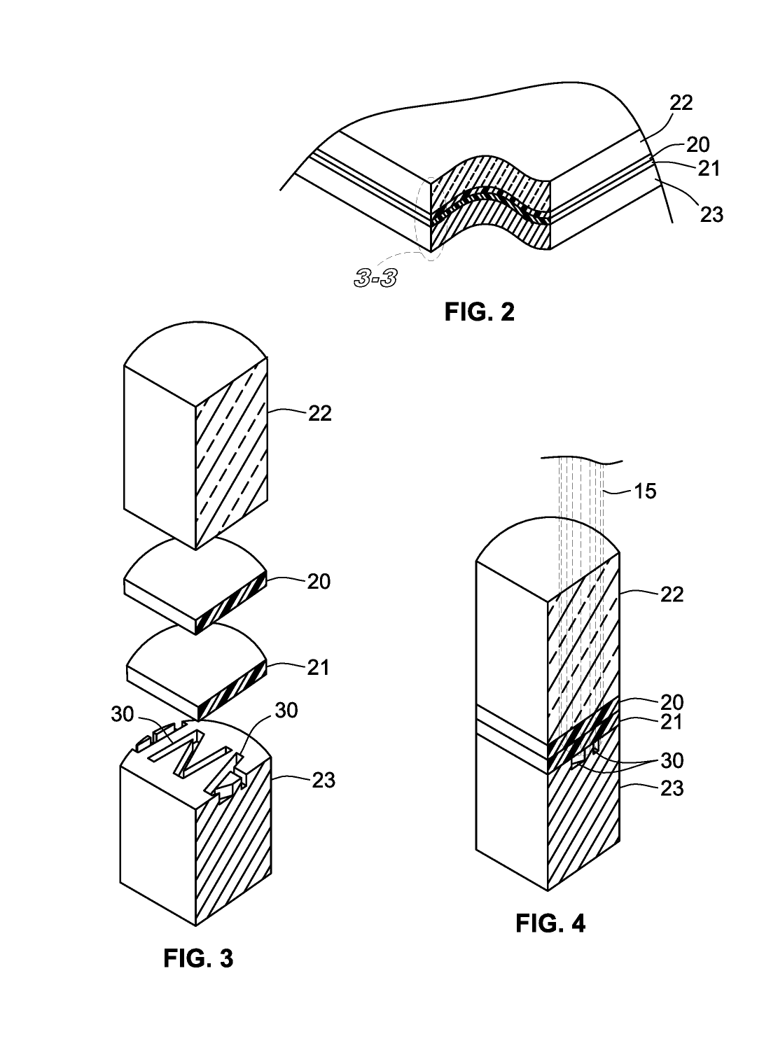

The upper clamping plate 22 is pressed downwardly on the upper workpiece 20 by a controllable actuator to clamp the workpieces 20 and 21 firmly against the lower plate 23. The downward pressure is maintained on the workpieces 20, 21 while the laser beam 15 traverses a prescribed weld zone or path, progressively heating the thermoplastic workpieces to melt the thermoplastic material in the weld zone to fuse the workpieces together in that zone. The weld is then completed by allowing the workpieces to cool under pressure, thereby solidifying the thermoplastic material that was melted by the laser in the weld zone. This heating and cooling of the thermoplastic materials progresses along the prescribed weld zone as the laser beam is advanced along that zone, which typically extends around the entire circumference of the workpieces, as in the example shown in FIG. 1.

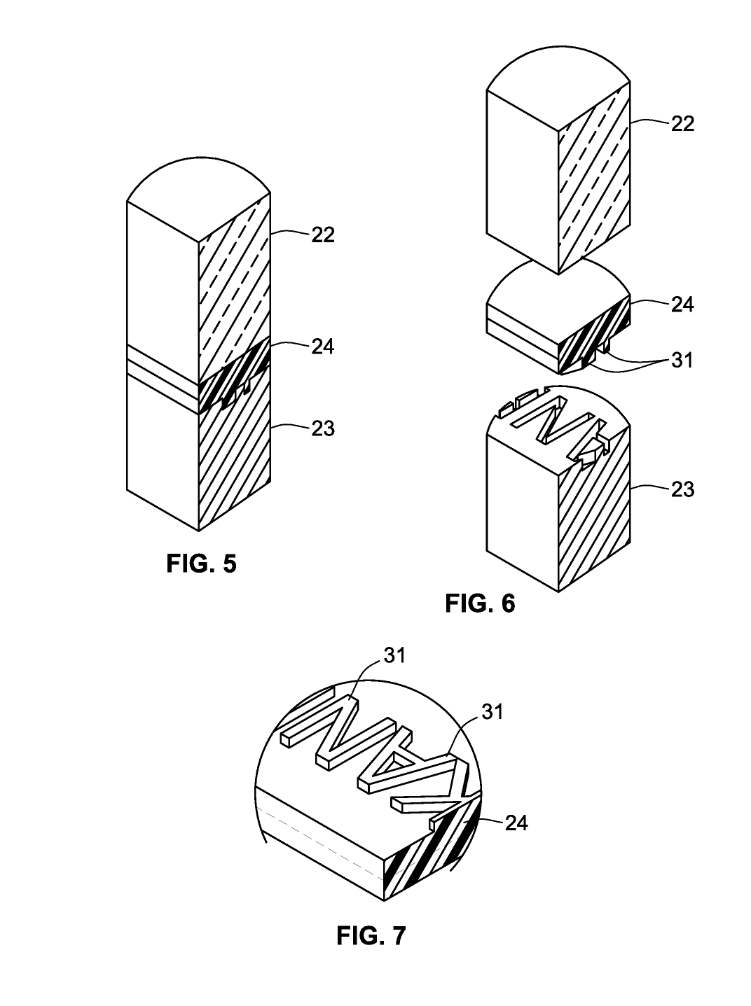

In the exemplary embodiment illustrated in the drawings, the laser beam 15 is transmitted downwardly through the transparent upper clamping plate 22 and two sheets of thermoplastic material 20 and 21 which are the workpieces to be welded. The two sheets 20 and 21 are optically transparent but nevertheless absorb part of the laser beam 11 when it is a 2-micron (2 μm.) fiber laser. Two-micron lasers are characterized by greatly increased absorption by unfilled polymers, which enables highly controlled melting through the thickness of the parts, which can be optically clear without the need of any laser sensitive additives. As illustrated in FIGS. 4 and 5, the heat produced by the partial absorption of the laser beam 15 in both sheets 20 and 21 melts the material in the sheets sufficiently to cause them to fuse together along the path of the laser beam 15 as the upper clamping plate 22 continuously presses the two sheets against each other, thereby producing the desired welding of the two sheets of thermoplastic material in the weld zone traversed by the laser beam 15. The resulting weld seam is a clear weld where the two clear workpieces are fused together.

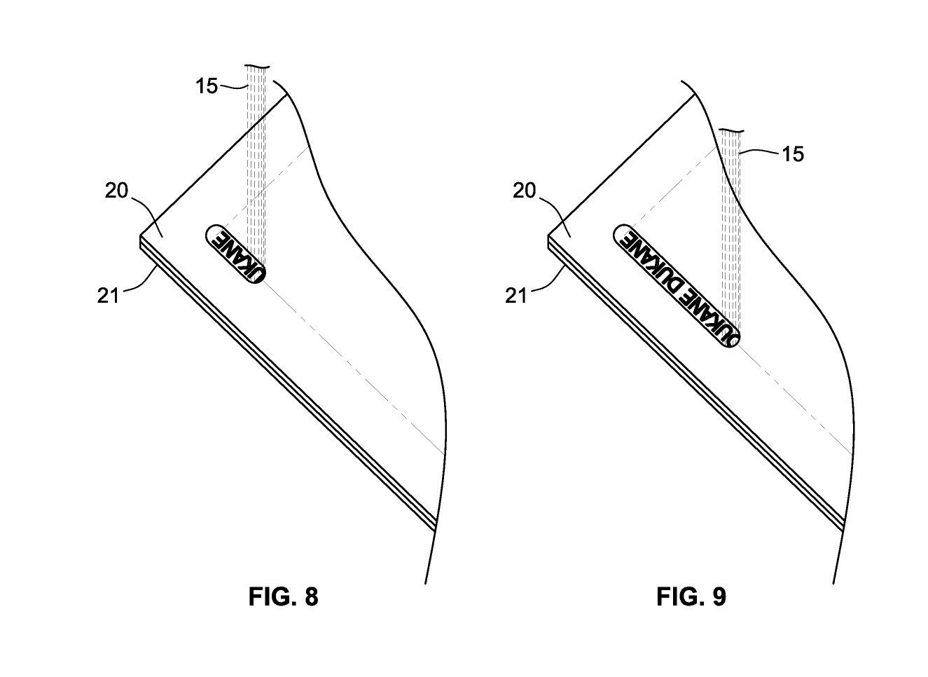

As the lower sheet 21 is melted in the path of the laser beam 15, the thermoplastic material of that sheet is pressed into cavities 30 etched or engraved in the lower clamping plate 23, as illustrated in FIGS. 4 and 5. After the laser beam 15 passes any given cavity 30, the thermoplastic material that flowed into that cavity solidifies, along with the adjacent portions of the fused sheets, thereby producing an embossed bottom surface 31 on the weld seam, without compromising the integrity of the weld seam. This embossed surface 31 replicates the image formed by the cavities 30 in the lower clamping plate 23, and this image is clearly visible in the weld seam of the welded sheets when they are removed from the clamping plates, because of the reflecting surfaces of the embossed image, as illustrated in FIGS. 8 and 9. Clamping pressure is preferably maintained on the welded films until the embossed surface has completely solidified, to maintain the shape of the embossed surface.

The image that is etched or engraved in the base plate may be a company name, a corporate logo, a trademark, marketing or advertising material, etc. The image can be used, for example, as protection against counterfeiting or use of out-of-date drugs, by using any given image only during a prescribed date range or only for designated customers. The image can also be designed so that it will be noticeably altered whenever the weld joint is broken, so the package effectively becomes “tamper-proof.”

It is preferred to form the embossed image continually along the entire length of the weld seam, to form a tamper-proof seal, as illustrated in FIGS. 8 and 9, for example. That is, if the weld seam is broken at any point along its length, the breaking of the seam will distort or tear the embossed image so that broken seam immediately becomes detectible by simply looking at the image.

The invention is applicable but not limited to packaging of consumer goods, medical products, and other products which required sealed packages. The image produced in the weld seam may be a trademark, marketing information, a corporate logo or other readable useful information.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

1. A laser welding method for joining portions of two workpieces of thermoplastic material that can be transparent to visible light, said method comprising
clamping together the portions of said workpieces to be joined, against a baseplate having an upper surface containing cavities that form an image to be replicated in the joined portions of said workpieces,
applying laser radiation to the portions of the clamped workpieces to be joined, to melt those portions of the clamped workpieces to be joined and to replicate said image in the joined portions of the clamped workpieces,
solidifying the molten portions of said workpieces while said workpieces remain clamped together against said backplate, and
removing the solidified, joined workpieces from said backplate.

2. The laser welding method of claim 1 in which said cavities are engraved or etched in the upper surface of said baseplate.

3. The laser welding method of claim 1 in which said workpieces are optically transparent sheets of thermoplastic material.

4. The laser welding method of claim 1 in which said workpieces are made of thermoplastic materials that absorb a portion of said laser radiation, so that both workpieces are heated by said laser radiation.

5. The laser welding method of claim 1 in which a portion of the melted workpiece material flows into the engraved or etched portions of said baseplate.

6. The laser welding method of claim 5 which produces an embossed surface on a surface of the joined portions of said workpieces, and said workpieces are clear films.

7. The laser welding method of claim 1 in which said laser radiation is a beam having a wavelength of about 2 microns.

8. The laser welding method of claim 6 in which the power of said laser radiation and the rate of movement of said laser radiation along said clamped workpieces is controlled to melt said workpieces in the areas to be joined.

9. The laser welding method of claim 1 in which said baseplate is made of a material that is non-transmissive for said laser radiation.

10. A laser welding system for joining portions of two workpieces of thermoplastic material that can be transparent to visible light, said system comprising
a pair of clamping plates positioned to engage opposite sides of said first and second workpieces when said workpieces are adjoining each other with contacting surfaces, one of said clamping plates having cavities that form an image to be replicated in the joined portions of said workpieces,
an actuator urging at least one of said clamping plates toward the other clamping plate to press said workpieces together, and
a laser source applying laser radiation to the portions of the clamped workpieces to be joined, from the opposite side of said workpieces from the side engaging the plate surface having said cavities, to melt those portions of the clamped workpieces and to replicate said image in the joined portions of the clamped workpieces.

11. The laser welding system of claim 10 in which said cavities are engraved or etched in the surface of said one of said clamping plates.

12. The laser welding system of claim 10 in which said workpieces are made of thermoplastic materials that absorb a portion of said laser radiation, so that both workpieces are heated by said laser radiation.

13. The laser welding system of claim 10 in which said laser radiation has a wavelength of about 2 microns.

14. The laser welding system of claim 10 in which said clamping plate having said cavities is made of a material that is non-transmissive for said laser radiation.
